(19) United States
(12) Patent Application Publication
(10) Pub. No.: US 2026/0095068 A1
(43) Pub. Date: Apr. 2, 2026

(54) System and Method of Power Estimation for Wireless Power Transfers

(71) Applicant: ZEBRA TECHNOLOGIES CORPORATION, Lincolnshire, IL (US)

(72) Inventors: Stalin Kumaravel, East Setauket, NY (US); christopher P. Klicpera, Westbury, NY (US)

(21) Appl. No.: 18/902,841

(22) Filed: Sep. 30, 2024

(51) Int. Cl. H02J 50/80; H02J 7/00; H02J 13/00; H02J 50/10

(52) U.S. Cl. CPC H02J 50/80; H02J 7/82; H02J 13/12; H02J 50/10

(57) ABSTRACT

A wireless power transmitter performs power monitoring based on detection of power transfer initiation and termination request messages inherent to a wireless power transfer protocol. By linking the power monitoring to the messages in the wireless power transfer protocol, the wireless power transmitter is capable of monitoring power without requiring the introduction of additional, special purpose hardware or circuitry, thereby reducing the cost, size, and complexity of a wireless power transmitter and/or receiver implementing these techniques.

### FIELD OF THE DISCLOSURE

The present disclosure relates to wireless power transfer systems, and more particularly, to monitoring and controlling power usage by a wireless power transmitter based on a wireless power transfer protocol.

### BACKGROUND

Wireless power transfer systems are capable of transmitting electrical energy from a transmitter to a receiver without using a physical link. For example, in existing near field wireless power transfer systems, a wireless power transmitter forms an inductive coupling with a receiver when the receiver is placed on or near an inductive charging pad or other wireless charging contact point of the wireless power transmitter. These systems can be used, for example, to charge batteries of smartphones, tablets, RFID devices, medical devices, etc.

Existing wireless power transfer systems largely fail to thoroughly and accurately monitor the power used by the wireless power transmitter over the course of a charging session. Solutions for monitoring power usage in the wireless power transmitter often require adding additional hardware elements (and hence, size and cost) to the wireless power transmitter and/or to the receiver.

### SUMMARY

In some embodiments, a wireless power transmitter is provided. The wireless power transmitter may include one or more processors and one or more non-transitory memories. The one or more non-transitory memories may store instructions that, when executed via the one or more processors, cause the wireless power transmitter to (i) obtain a first message comprising a device identification or a power transfer initiation request from a wireless power receiver via a wireless electrical coupling, the first message being transmitted by the wireless power receiver according to a wireless power transfer protocol, (ii) responsive to obtaining the first message, initiate a monitoring of power usage of the wireless power transmitter over a charging session corresponding to power transfer to a battery of the wireless power receiver over the wireless electrical coupling between the wireless power transmitter and the wireless power receiver, (iii) obtain a second message comprising a power transfer termination request from the wireless power receiver via the wireless electrical coupling, the second message being transmitted by the wireless power receiver according to the wireless power transfer protocol, (iv) responsive to obtaining the second message, terminate the monitoring of the power usage, and (v) based on the monitoring, determine an amount of power used by the wireless power transmitter over the charging session between the obtaining of the first message and the obtaining of the second message.

In some embodiments, a computer-implemented method is performed via one or more processors of a wireless power transmitter. The method may include (i) obtaining a first message comprising a device identification or a power transfer initiation request from a wireless power receiver via a wireless electrical coupling, the first message being transmitted by the wireless power receiver according to a wireless power transfer protocol, (ii) responsive to obtaining the first message, initiating a monitoring of power usage of the wireless power transmitter over a charging session corresponding to power transfer to a battery of the wireless power receiver over the wireless electrical coupling between the wireless power transmitter and the wireless power receiver, (iii) obtaining a second message comprising a power transfer termination request from the wireless power receiver via the wireless electrical coupling, the second message being transmitted by the wireless power receiver according to the wireless power transfer protocol, (iv) responsive to obtaining the second message, terminating the monitoring of the power usage, and (v) based on the monitoring, determining an amount of power used by the wireless power transmitter over the charging session between the obtaining of the first message and the obtaining of the second message.

In some embodiments, one or more non-transitory computer readable media store instructions that, when executed via one or more processors of a wireless power transmitter, cause a wireless power transmitter to (i) obtain a first message comprising a device identification or a power transfer initiation request from a wireless power receiver via a wireless electrical coupling, the first message being transmitted by the wireless power receiver according to a wireless power transfer protocol, (ii) responsive to obtaining the first message, initiate a monitoring of power usage of the wireless power transmitter over a charging session corresponding to power transfer to a battery of the wireless power receiver over the wireless electrical coupling between the wireless power transmitter and the wireless power receiver, (iii) obtain a second message comprising a power transfer termination request from the wireless power receiver via the wireless electrical coupling, the second message being transmitted by the wireless power receiver according to the wireless power transfer protocol, (iv) responsive to obtaining the second message, terminate the monitoring of the power usage, and (v) based on the monitoring, determine an amount of power used by the wireless power transmitter over the charging session between the obtaining of the first message and the obtaining of the second message.

In some embodiments, determining the amount of power used includes determining an amount of power received by the wireless power receiver based on one or more wireless power transfer efficiency values associated with the wireless electrical coupling, wherein the amount of power received is less than the amount of power used.

In some embodiments, the wireless power transmitter stores, at one or more memories, indications of respective amounts of power used by the wireless power transmitter to provide power to a plurality of wireless power receivers.

In some embodiments, the wireless power transmitter estimates a remaining service lifetime of the battery of the wireless power receiver based on the determined amount of power used.

In some embodiments, the wireless power transmitter (i) monitors power used by the wireless power transmitter in each of a plurality of charging sessions with the wireless power receiver, (ii) stores, at one or more memories, indications of respective amounts of power used for each of the plurality of charging sessions, and (iii) generates a device usage profile describing use of the wireless power receiver based on at least one of (a) the respective amounts of power used for each of the plurality of charging sessions, (b) a time elapsed between any two of the plurality of charging sessions, or (c) a starting or ending charge level of the battery of the wireless power receiver in one or more of the plurality of charging sessions.

In some embodiments, the wireless power transmitter transmits, to the wireless power receiver via the wireless electrical coupling and using the wireless power transfer protocol, an indication of the amount of power used.

In some embodiments, the wireless power transmitter stores an indication of the amount of power used at one or more memories.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts an example wireless power transfer system, in accordance with various embodiments described herein.

FIG. 2 depicts an example computer-implemented method, in accordance with various embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure describes systems and methods that monitor power usage in a wireless power transmitter. More particularly, systems and methods herein monitor the power usage by monitoring the specific message exchanges native to a wireless power transfer protocol used to wirelessly transmit electrical power and data between the wireless power transmitter and a wireless power receiver to determine the start, end, and magnitude of the power transfer. By determining the transmitter power usage using the message exchanges inherent to the wireless power transfer protocol, the systems and methods herein determine the power usage without requiring additional special purpose hardware or circuitry to be provided in the wireless power transmitter and/or receiver. This aspect of the systems and methods herein may make the systems and methods particularly suitable for use in a variety of wireless power transfer systems, including for example systems for charging consumer electronic devices such as smartphones, tablets, RFID devices, and/or medical devices. As will be described further herein, the systems and methods herein may use the determinations of power usage, for example, to (i) track one, two, three, four, or more wireless power transfer (“charging”) sessions between the wireless power transmitter and each of one, two, three, four or more respective receivers, (ii) determine a usage profile of each of the one, two, three, four or more receivers, and/or (iii) estimate a battery remaining service lifetime of each of the one, two, three, four or more receivers based on the wireless power transfers.

As used herein, “power transfer” particularly refers to a providing of electrical charge between a wireless power transmitter and a device receiving the provided electrical charge (“wireless power receiver,” e.g., a smartphone, tablet, medical device, etc.). The power transfer is provided over a wireless electrical coupling with the between the wireless power transmitter and wireless power receiver (e.g., induction coils of the wireless power transmitter and wireless power receiver, respectively). Typically, but not necessarily, the wireless power receiver stores the received electrical charge in one or more batteries (e.g., an internal battery).

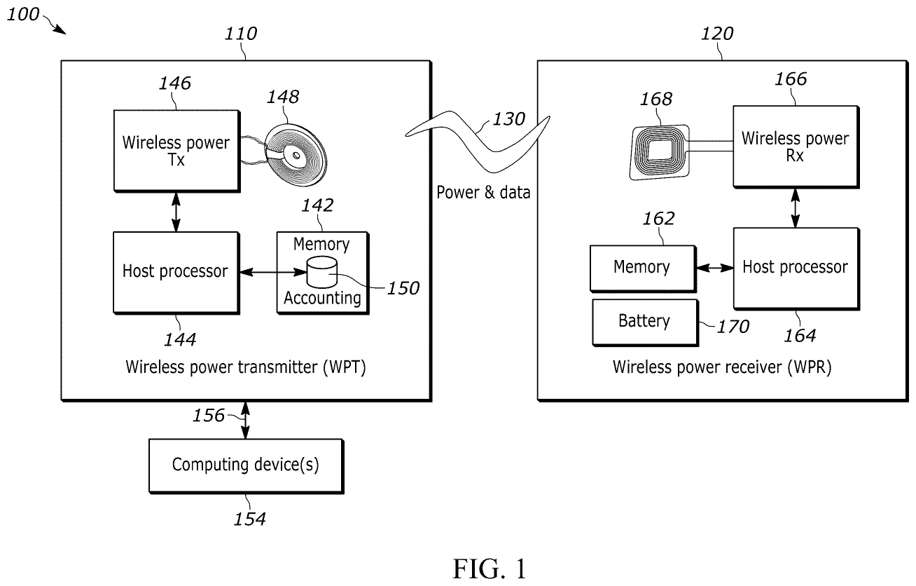

FIG. 1 depicts an example wireless power transfer system 100, in accordance with various embodiments. The wireless power transfer system 100 includes a wireless power transmitter (WPT) 110 and a wireless power receiver (WPR) 120. Generally, the WPT 110 is configured to transfer power to the WPR 120 via a wireless electrical link 130. As will be described in further detail, wireless power transfer between the WPT 110 and WPR 120 may use a wireless power transfer protocol that involves using electrical signals between the WPT 110 and WPR 120 to communicate data, in addition to providing power (e.g., using the Qi wireless protocol, a proprietary protocol built on top of the Qi protocol, and/or another suitable protocol(s)). Specifically, the data communications in each direction may be performed via frequency shifting and/or amplitude shifting of transfers of current over the link 130, where the WPT 110 and WPR 120 are programmed to generate the data communications and interpret communications received over the link 130. Accordingly, the wireless electrical link 130 is also characterized herein as a “power and data link.”

The WPT 110 includes a memory 142 (i.e., one or more memories), which may for example include volatile and/or non-volatile memory. In particular, the memory 142 may store non-transitory instructions that, when executed via a host processor 144 (i.e., one or more processors), cause the WPT 110 to operate as described herein. These operations of the WPT 110 include using a wireless power transfer protocol to transfer power to the WPR 120 (e.g., including exchanging data with the WPR 120), and/or performing power monitoring operations. Particularly, the wireless power transmitter may perform the wireless power transfer via a wireless power transmit (Tx) port 146 and an induction coil 148. The induction coil 148 may, for example, be implemented in a charging pad or other charging surface, such that placing the WPR 120 upon the charging pad or surface enables the WPT 110 and WPR 120 to become inductively coupled to enable the wireless power transfer.

As will be described in further detail, the wireless power transfer may perform monitoring of power used by the WPT 110 to perform the power transfer. The WPT 110 may, for example, store indications of the used power at a data storage 150 (“accounting”) at the memory 142, and/or provide indications of the used power and/or other data to one or more other computing devices 154 via one or more communication links 156 (e.g., for long-term storage at the one or more computing devices 154, further analyses of the used or provided power, etc.).

The WPR 120 may include a memory 162 (i.e., one or more memories), which may for example include volatile and/or non-volatile memory. In particular, the memory 142 may store non-transitory instructions that, when executed via a host processor 164, cause the wireless power receiver 110 to operate as described herein, e.g., to receive a wireless power transfer and data communications from the WPT 110. The WPR 120 may receive the wireless power transfer via a wireless power receive (Rx) port 166 and an induction coil 168, which may be inductively coupled to the induction coil 148 to receive the wireless power transfer and exchange data with the WPT 110. The WPR 120 includes a rechargeable battery 170 electrically coupled to the induction coil 168 and/or the Rx port 166, so as to receive and store current received through the wireless power transfer.

The wireless power transfer between the WPT 110 and WPR 120 may be performed according to an established wireless power transfer protocol (e.g., Qi protocol and/or another suitable protocol described herein), where both the WPT 110 and WPR 120 are configured to operate according to the protocol. For example, each of the memory 142 and the memory 162 may store instructions that, when executed by the host processor 144 and host processor 164 respectively, cause the WPT 110 and WPR 120 respectively to (i) generate messages in accordance with the protocol, (ii) transmit the messages in the form of electrical currents over the link 130, and (iii) receive and identify messages received over the link 130.

Example actions associated with wireless power transfer and data communications in accordance with the Qi wireless power transfer protocol are discussed below. It should be appreciated that, in some embodiments, the techniques of this disclosure may additionally or alternatively be implemented via another one or more wireless power transfer protocols. In some embodiments, order of at least some of the described actions may vary from the order in which the actions are discussed below.

First, the WPT 110 is enabled for a wireless power transfer, for example by being connected to its own power source (e.g., an AC power source or a battery of the WPT 110) and turned on, booted, configured, etc. The WPR 120 may then be placed on a charging pad of the WPT 110. Although a “charging pad” is described herein, any suitable charging surface may be used such that the induction coil 148 of the WPT 110 and the induction coil 168 of the WPR 120 are placed in proximity to enable a sustained inductive coupling of the coils to perform the wireless power transfer and data communications.

Upon being placed on the charging pad, the WPR 120 detects availability of power from the WPT 110, e.g., based on the WPR 120 receiving at least a baseline current from the WPT 110. Upon detecting the power availability, the WPR 120 may initiate an identification process by transmitting identification information of the WPR over the link 130. The identification information may be stored, for example, at the memory 162, and the WPR 120 may be configured to convert the identification information to data in the form of amplitude and/or frequency shifts over the link 130. Upon receiving the identity information from the WPR 120 over the link 110, the WPT verifies an identity of the WPR 120 based on the identification information, e.g., based on locally stored information to determine that the WPR 120 is a previously recognized device or otherwise is a device capable of receiving the wireless power transfer from the WPT 110. Upon verifying the identity of the WPR 120, the WPT 110 may respond to the WPR 120 with a success message, e.g., using power frequency and/or amplitude shifting over the link 130.

Having completed the identification process upon transmitting the success message, the WPT 110 is prepared to begin charging the WPR 120. According to the systems and methods of this disclosure, the WPT 110, may then begin a wireless power transfer monitoring session for the wireless power transfer to the WPR 120, such that power subsequently transferred by the WPT 110 to the WPR 120 will be tracked over a wireless power transfer session (“charging session”). The monitored power usage may be provided, for example, to the data storage 150, the memory 162, and/or the one or more computing devices 154.

According to the Qi protocol, after the WPR 120 receives the success message from the WPT 110, the WPR 120 requests power from the WPT 110 (i.e., a power initiation message, e.g., by requesting a particular amount of current, and/or by requesting a particular amount of power as a function of the current and a voltage of the WPR 120). In embodiments, the WPR 120 may subsequently update a power request one or more times over the course of the wireless power transfer (e.g., by requesting more power and/or current, or by requesting less power and/or current as the battery approaches a full (100%) charge level).

Upon receiving the request for power from the WPR 120, the WPT may determine whether the requested power is available from the WPT 110. If the requested power is available, the WPT 110 may respond to the WPR 120 confirming the available power. If the requested power is not available, the WPT 110 may respond to the WPR 120 indicating the lack of sufficient power availability, and the WPT 110 and the WPR 120 may renegotiate the power to be provided in the wireless power transfer. Verification of power availability may later repeat if and when the WPR 120 requests a different amount of power from the WPT 110 at any point during the charging session.

As the WPT 110 begins the wireless power transfer, the host processor 144 may track and record the used power over time at the data storage 150 (e.g., by recording a used current and voltage over time, and/or by recording power intermittently calculated as a function of the used current and voltage). In any case, the WPT 110 continues monitoring and recording the power as long as the charging session continues.

As the WPR 120 receives power, the WPR 120 may monitor a charge level of the battery 170. When the WPR 120 no longer requires power (e.g., upon a determination that the battery 170 is fully charged), the WPR 120 may send a request to the WPT 110 over the link 130 to stop the wireless power transfer (power transfer termination request). The WPT 110 may then terminate the wireless power transfer, thereby ending the charging session. Alternatively, the charging session may terminate at any point if the WPR 120 is removed from the charging pad of the WPT 110, breaking the inductive coupling for the wireless power transfer.

Upon the termination of the charging session, the host processor 144 of the WPT 110 may terminate monitoring and recording of provided power for the charging session. Based on the monitored power transfer, the WPT 110 may determine a total power use by the WPT 110 over the charging session. The WPT 110 may provide an indication of the total power, for example, to the WPR 120 over the link 130, and/or to the one or more computing devices 154 over the one or more communication links 156. In embodiments where the WPR 120 receives the indication of the total power, the WPR 120 may store the indication of the total power at the memory 162.

In some embodiments, additionally or alternatively to monitoring the power used by the WPT 110 in the charging session, the WPT 110 may monitor an actual amount of power delivered to the WPR 120. That is, due to losses over the link 130, the power used by the WPT 110 may differ from the power received by the battery 170 of the WPR 120. In some embodiments, the WPT 110 may receive data communications from the WPR 120 over the link 130 indicating actual power received by the WPR 120. Additionally or alternatively, in some embodiments, the WPT 110 may determine or estimate a power received by the WPR 120 from any power output of the WPT 110. For example, the memory 142 of the WPT 110 may store a lookup table storing power transfer efficiency values based on one or more of (i) a device identifier of the WPR 120, (ii) a charge level of the battery 170 of the WPR 120, (iii) a wireless power transfer protocol used for the power transfer, and/or (iv) a voltage of the WPT 110 and/or the WPR 120. The WPT 110 may obtain values for any one or more of the above parameters (e.g., from the memory 142, from the one or more computing devices 154, and/or from the WPR 120 using data communications over the link 130) and reference the lookup table to determine a wireless power transfer efficiency value for any charging session or portion thereof. The wireless power transfer efficiency value may for example be represented as a value on a continuous interval between 0 and 1.0, where 1.0 represents no difference between power output and power received and 0 represents no power received by the WPR for any power output of the WPT 110. By multiplying the efficiency value for a charging session (or portion thereof) by the power output of the WPT 110 for the corresponding charging session (or portion thereof), the WPT 110 may determine actual power received by the WPR 120.

In some embodiments, the WPT 110 may estimate a remaining lifetime of the battery 170 upon the termination of the charging system. The remaining battery lifetime may for example be based on (i) power used by the WPT 110, (ii) actual power received by the WPR 120, (iii) a charge level of the battery 170 upon the termination of the charging session, and/or (iv) a time between the charging session and a previous charging session, and/or (v) past charge levels and power amounts provided to the WPR 120. For example, the WPT 110 may estimate a remaining service lifetime of the battery 170 based on the observed ability of the battery 170 to hold charge at a present time compared to at an original time of manufacture of the battery 170. For instance, upon charging the battery 170 to 100% of a capacity of the battery 170, the WPT 110 may use the monitored power information to determine how much charge was actually provided to the battery 170, and determine how much charge represents 100% capacity of the battery 170 in its current state. By comparing the present capacity to the capacity from the time of manufacture, the WPT 110 may determine a health of the battery 170. Based on observed information indicating progressive health trends of similar batteries (e.g., representing gradual loss of charging capacity over many cycles), the WPT 110 may determine the remaining service lifetime of the battery 170, e.g., in terms of a number of remaining charging cycles and/or an amount of time.

Additionally or alternatively to estimating the remaining service lifetime, the WPT 110 may estimate a single-cycle lifetime of the battery 170. For example, if the WPT 110 previously charged the battery 170 to a 100% charge level in a previous session and a subsequent charging session three days later charged the battery 170 from a 0% charge level to a 50% charge level, the WPT 110 may estimate the remaining lifetime of the battery 170 at approximately one and a half days.

In some embodiments, the WPT 110 may generate, store, and/or transmit a usage profile of the WPR 120 based on information associated with one, two, three, four or more charging sessions for the WPR 120. The usage profile may for example describe a frequency and/or intensity of use of the WPR 120 based for example on (i) amounts of power provided by the WPT 110 to the WPR 120 during any charging session(s), (ii) times elapsed between any two charging sessions, and/or (ii) charge levels of the battery 170 at the start and/or end of any charging session(s). The WPT 110 may store the usage profile at the memory 142, provide the usage profile to the WPR 120 over the link 130, and/or provide the usage to the one or more computing devices 154 over the communication link 156.

In embodiments, the WPT 110 may repeat the above operations for two, three, four, or more devices wirelessly charged by the WPT 110 (i.e., multiple different WPRs 120). For example, the WPT 110 may perform power transfer monitoring, determine power transfer efficiency, and/or generate usage profiles separately for different respective WPRs 120. In embodiments in which the WPT 110 transmits power transfer information to the WPR 120, the WPT 110 may provide to the WPR 120 only the information that is specific to the WPR 120 (e.g., the WPR 120 does not receive information about charging sessions for other charged devices).

Although the foregoing describes power monitoring, efficiency determination, usage profile generation, and other functionalities being performed by the WPT 110, it is envisioned that, in some embodiments, similar functionalities may be additionally or alternatively be performed by the WPR 120 (e.g., by the host processor 164 executing instructions stored at the memory 162). For example, the WPR 120 may monitor power received by the WPR 120, and/or determine power used by the WPT 110 by receiving indications of power used over the link 130 and/or by referencing an efficiency lookup table at the memory 162 to determine the used power based on the efficiency and the power received in a charging session or portion thereof. As another example, the WPR 120 may generate and store a usage profile at the memory 162, and may transmit indications of the usage profile to the WPT 110 over the link 130.

By basing the above-described functionalities on the detection of messages inherent to the wireless power transfer protocol, the systems and methods herein may fully and accurately monitor power usage in the wireless power transmitter without requiring additional, special purpose hardware or circuitry beyond the minimum memory, processor, and circuitry needed to perform the wireless power transfer itself. Thus, use the systems and methods herein may enable wireless power transfer monitoring without increasing the size, cost, and/or complexity of the wireless power transmitter and/or wireless power receiver, thereby making the systems and methods herein applicable to a wide variety of electronic devices, including but not necessarily limited to smartphones, tablets, RFID devices, and medical devices.

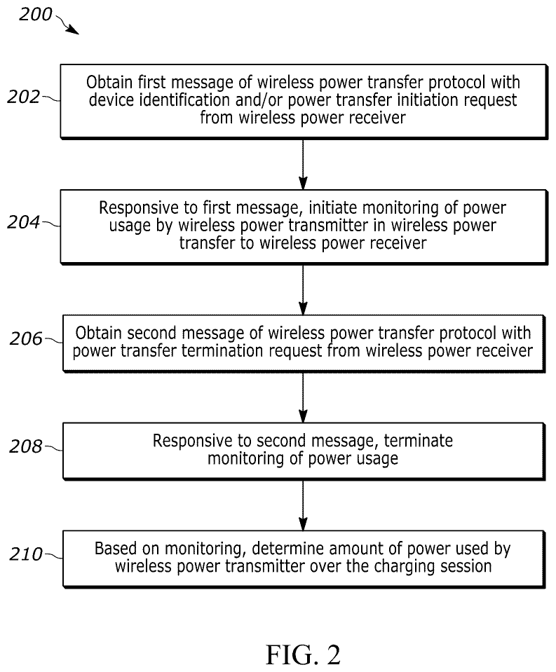

FIG. 2 depicts a block diagram of an example computer-implemented method 200, in accordance with various embodiments. Generally speaking, actions of the method 200 may be performed via the wireless power transfer system 100 described with respect to FIG. 1, and may include at least some of the actions of the system 100 as described in the foregoing. More particularly, actions of the method 200 may be performed via the WPT 110. For example, the memory 142 (i.e., one or more memories) may store instructions that, when executed via host processor 144 (i.e., one or more processors), cause the WPT 110 to perform actions of the method 200 (e.g., via the Tx port 146 and/or the induction coil 148, using the link 130).

FIG. 2 depicts a block diagram of an example computer-implemented method 200. The method 200 may be performed, for example, via a wireless power transmitter such as the WPT 110 of FIG. 1. For example, one or more memories (e.g., the memory 142) may store non-transitory instructions that, when executed via one or more processors (e.g., the host processor 144), cause the WPT 110 to perform actions of the method 200. In some embodiments, one or more non-transitory computer readable media store instructions that, when executed via one or more processors (e.g., the host processor 144) of a wireless power transmitter (e.g., the WPT 110), cause the wireless power transmitter to perform actions of the method 200.

The method includes obtaining a first message over a wireless electrical coupling (202). The first message includes a device identification of a wireless power receiver (WPR), and/or a power transfer initiation request from the WPR. The first message is transmitted by the WPR according to a wireless power transfer protocol (e.g., Qi protocol and/or another suitable protocol described herein).

The method 200 further includes, responsive to obtaining the first message, initiating a monitoring of power usage of the WPT over a charging session (204). The charging session corresponds to power transfer from the WPT to a battery of the WPR over the wireless electrical coupling between the WPT and the WPR.

The method 200 still further includes obtain a second message from the WPR over the wireless electrical link (206). The second message includes a power transfer termination request, and is transmitted by the WPR according to the wireless power transfer protocol.

The method 200 still yet further includes, responsive to obtaining the second message, terminating the monitoring of the power usage (208). Alternatively, in some embodiments, the monitoring may be terminated in response to determining that the wireless electrical coupling has otherwise been interrupted, e.g., if the WPR has been removed from a charging pad of the WPT before completion of the charging session.

The method 200 further includes, based on the monitoring, determining an amount of power used by the WPT over the charging session between the obtaining of the first message and the obtaining of the second message (210).

In some embodiments, determining the amount of power used includes determining an amount of power received by the WPR based on one or more wireless power transfer efficiency values associated with the wireless electrical coupling, wherein the amount of power received is less than the amount of power used.

In some embodiments, the method 200 further includes storing, at one or more memories of the WPT, indications of respective amounts of power used by the wireless power transmitter to provide power to a plurality of WPRs.

In some embodiments, the method 200 further includes estimating a lifetime of the battery of the WPR based on the determined amount of power used.

In some embodiments, the method 200 additionally includes (i) monitoring power used by the WPT in each of a plurality of charging sessions with the WPR, (ii) storing, at one or more memories of the WPT, indications of respective amounts of power used for each of the plurality of charging sessions, and/or (iii) generating a device usage profile describing use of the WPR based on at least one of (a) the respective amounts of power used for each of the plurality of charging sessions, (b) a time elapsed between any two of the plurality of charging sessions, or (c) a starting or ending charge level of the battery of the WPR in one or more of the plurality of charging sessions.

In some embodiments, the method 200 further includes transmitting, to the WPR via the wireless electrical coupling and using the wireless power transfer protocol, an indication of the amount of power used.

In some embodiments, the method 200 further includes storing an indication of the amount of power used at one or more memories of the WPT.

The method 200 may include still additional, fewer, and/or alternative actions, including various techniques of this disclosure, in various embodiments. Moreover, although the method 200 as described above may be performed by the wireless power transmitter, it is envisioned that in some embodiments, at least some of the actions of the method 200 (and/or analogous actions) may be performed by a wireless power receiver (e.g., the WPR 120 of FIG. 1, for example via the host processor 164 executing non-transitory instructions stored at the memory 162).

### Additional Considerations

In the foregoing specification, specific embodiments/aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations/aspects should not be interpreted as mutually exclusive, and should instead be understood as potentially combinable if such combinations are permissive in any way. In other words, any feature disclosed in any of the aforementioned embodiments, examples, implementations, or aspects may be included in any of the other aforementioned embodiments, examples, implementations, or aspects.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A wireless power transmitter comprising:
one or more processors; and
one or more non-transitory memories storing instructions that, when executed by the one or more processors, cause the wireless power transmitter to:
obtain a first message comprising a device identification or a power transfer initiation request from a wireless power receiver via a wireless electrical coupling, the first message being transmitted by the wireless power receiver according to a wireless power transfer protocol;
responsive to obtaining the first message, initiate a monitoring of power usage of the wireless power transmitter over a charging session corresponding to power transfer to a battery of the wireless power receiver over the wireless electrical coupling between the wireless power transmitter and the wireless power receiver;
obtain a second message comprising a power transfer termination request from the wireless power receiver via the wireless electrical coupling, the second message being transmitted by the wireless power receiver according to the wireless power transfer protocol;
responsive to obtaining the second message, terminate the monitoring of the power usage; and
based on the monitoring, determine an amount of power used by the wireless power transmitter over the charging session between the obtaining of the first message and the obtaining of the second message.

2. The wireless power transmitter of claim 1, wherein the instructions to determine the amount of power used further include instructions to determine an amount of power received by the wireless power receiver based on one or more wireless power transfer efficiency values associated with the wireless electrical coupling, wherein the amount of power received is less than the amount of power used.

3. The wireless power transmitter of claim 1, wherein the instructions, when executed by the one or more processors, further cause the wireless power transmitter to store, at the one or more memories, indications of respective amounts of power used by the wireless power transmitter to provide power to a plurality of wireless power receivers.

4. The wireless power transmitter of claim 1, wherein the instructions, when executed by the one or more processors, further cause the wireless power transmitter to estimate a remaining service lifetime of the battery of the wireless power receiver based on the determined amount of power used.

5. The wireless power transmitter of claim 1, wherein the instructions, when executed by the one or more processors, further cause the wireless power transmitter to:
monitor power used by the wireless power transmitter in each of a plurality of charging sessions with the wireless power receiver;
store, at the one or more memories, indications of respective amounts of power used for each of the plurality of charging sessions; and
generate a device usage profile describing use of the wireless power receiver based on at least one of (i) the respective amounts of power used for each of the plurality of charging sessions, (ii) a time elapsed between any two of the plurality of charging sessions, or (iii) a starting or ending charge level of the battery of the wireless power receiver in one or more of the plurality of charging sessions.

6. The wireless power transmitter of claim 1, wherein the instructions, when executed by the one or more processors, further cause the wireless power transmitter to transmit, to the wireless power receiver via the wireless electrical coupling and using the wireless power transfer protocol, an indication of the amount of power used.

7. The wireless power transmitter of claim 1, wherein the instructions, when executed by the one or more processors, further cause the wireless power transmitter to store an indication of the amount of power used at the one or more memories.

8. A computer-implemented method performed via one or more processors of a wireless power transmitter, the method comprising:
obtaining a first message comprising a device identification or a power transfer initiation request from a wireless power receiver via a wireless electrical coupling, the first message being transmitted by the wireless power receiver according to a wireless power transfer protocol;
responsive to obtaining the first message, initiating a monitoring of power usage of the wireless power transmitter over a charging session corresponding to power transfer to a battery of the wireless power receiver over the wireless electrical coupling between the wireless power transmitter and the wireless power receiver;
obtaining a second message comprising a power transfer termination request from the wireless power receiver via the wireless electrical coupling, the second message being transmitted by the wireless power receiver according to the wireless power transfer protocol;
responsive to obtaining the second message, terminating the monitoring of the power usage; and
based on the monitoring, determining an amount of power used by the wireless power transmitter over the charging session between the obtaining of the first message and the obtaining of the second message.

9. The computer-implemented method of claim 8, wherein determining the amount of power used comprises determining an amount of power received by the wireless power receiver based on one or more wireless power transfer efficiency values associated with the wireless electrical coupling, wherein the amount of power received is less than the amount of power used.

10. The computer-implemented method of claim 8, further comprising storing, at one or more memories of the wireless power transmitter, indications of respective amounts of power used by the wireless power transmitter to provide power to a plurality of wireless power receivers.

11. The computer-implemented method of claim 8, further comprising estimating a remaining service lifetime of the battery of the wireless power receiver based on the determined amount of power used.

12. The computer-implemented method of claim 8, further comprising:
monitoring power used by the wireless power transmitter in each of a plurality of charging sessions with the wireless power receiver;
storing, at one or more memories of the wireless power transmitter, indications of respective amounts of power used for each of the plurality of charging sessions; and
generating a device usage profile describing use of the wireless power receiver based on at least one of (i) the respective amounts of power used for each of the plurality of charging sessions, (ii) a time elapsed between any two of the plurality of charging sessions, or (iii) a starting or ending charge level of the battery of the wireless power receiver in one or more of the plurality of charging sessions.

13. The computer-implemented method of claim 8, further comprising transmitting, to the wireless power receiver via the wireless electrical coupling and using the wireless power transfer protocol, an indication of the amount of power used.

14. The computer-implemented method of claim 8, further comprising store an indication of the amount of power used at one or more memories of the wireless power transmitter.

15. One or more non-transitory computer readable media storing instructions that, when executed via one or more processors of a wireless power transmitter, cause a wireless power transmitter to:
obtain a first message comprising a device identification or a power transfer initiation request from a wireless power receiver via a wireless electrical coupling, the first message being transmitted by the wireless power receiver according to a wireless power transfer protocol;
responsive to obtaining the first message, initiate a monitoring of power usage of the wireless power transmitter over a charging session corresponding to power transfer to a battery of the wireless power receiver over the wireless electrical coupling between the wireless power transmitter and the wireless power receiver;
obtain a second message comprising a power transfer termination request from the wireless power receiver via the wireless electrical coupling, the second message being transmitted by the wireless power receiver according to the wireless power transfer protocol;
responsive to obtaining the second message, terminate the monitoring of the power usage; and
based on the monitoring, determine an amount of power used by the wireless power transmitter over the charging session between the obtaining of the first message and the obtaining of the second message.

16. The one or more non-transitory computer readable media of claim 15, wherein the instructions to determine the amount of power used further include instructions to determine an amount of power received by the wireless power receiver based on one or more wireless power transfer efficiency values associated with the wireless electrical coupling, wherein the amount of power received is less than the amount of power used.

17. The one or more non-transitory computer readable media of claim 15, wherein the instructions, when executed by the one or more processors, further cause the wireless power transmitter to store, at one or more memories of the wireless power transmitter or at the one or more non-transitory computer readable media, indications of respective amounts of power used by the wireless power transmitter to provide power to a plurality of wireless power receivers.

18. The one or more non-transitory computer readable media of claim 15, wherein the instructions, when executed by the one or more processors, further cause the wireless power transmitter to estimate a remaining service lifetime of the battery of the wireless power receiver based on the determined amount of power used.

19. The one or more non-transitory computer readable media of claim 15, wherein the instructions, when executed by the one or more processors, further cause the wireless power transmitter to:
monitor power used by the wireless power transmitter in each of a plurality of charging sessions with the wireless power receiver;
store, at one or more memories of the wireless power transmitter or at the one or more non-transitory computer readable media, indications of respective amounts of power used for each of the plurality of charging sessions; and
generate a device usage profile describing use of the wireless power receiver based on at least one of (i) the respective amounts of power used for each of the plurality of charging sessions, (ii) a time elapsed between any two of the plurality of charging sessions, or (iii) a starting or ending charge level of the battery of the wireless power receiver in one or more of the plurality of charging sessions.

20. The one or more non-transitory computer readable media of claim 15, wherein the instructions, when executed by the one or more processors, further cause the wireless power transmitter to transmit, to the wireless power receiver via the wireless electrical coupling and using the wireless power transfer protocol, an indication of the amount of power used.
